(19) United States
(12) Patent Application Publication
(10) Pub. No.: US 2016/0213221 A1
(43) Pub. Date: Jul. 28, 2016

(54) SCRUBBING OR SCOURING PAD

(71) Applicant: SCRUB DADDY, INC., FOLCROFT, PA (US)

(72) Inventors: AARON C. KRAUSE, VOORHEES, NJ (US); JOHN O'BRIEN, FOLCROFT, PA (US)

(21) Appl. No.: 15/071,496

(22) Filed: Mar. 16, 2016

Related U.S. Application Data
(63) Continuation-in-part of application No. 13/617,762, filed on Sep. 14, 2012.

(51) Int. Cl. A47L 17/08; B29B 7/88; B29C 44/56; B29C 44/02

(52) U.S. Cl. CPC A47L 17/08; B29C 44/02; B29B 7/88; B29C 44/5681; B29K 2105/0032

(57) ABSTRACT

The scrubbing or scouring pad of the invention is an artificial sponge made from a foam material that changes firmness or rigidity based on the temperature thereof. The foam sponge is then covered with a plastic mesh to increase the scouring power thereof. If desired, the foam may also include thermochromic additives therein that change the color of the foam based on the temperature. This provides a visual indication of the temperature of the foam.

### CROSS REFERENCE TO RELATED APPLICATION

This application is a Continuation-in-Part of prior U.S. application Ser. No. 13/617,762, filed Sep. 14, 2012.

### FIELD OF THE INVENTION

The present invention is directed toward a scouring pad which is formed from the combination of a foam cleaning pad core surrounded by a scrubbing layer formed of a mesh or screen of somewhat rigid woven or nonwoven plastic. The core is made from a foam material that is soft in warm water but rigid in cold water. The combination is particularly useful for cleaning dishes or pots and pans or for substantially any other cleaning or scrubbing purpose. As will be seen, the scouring pad of the present invention has significant advantages over existing pads.

### BACKGROUND OF THE INVENTION

Artificial sponges made from various foamable plastics have been on the market for many years. These include both open cell and closed cell products that have been molded, extruded or otherwise formed into various shapes for numerous different purposes. In particular, artificial sponges have been used for many years for use as cleaning devices for cleaning dishes or tables or substantially any other products or services.

Several years ago, a product was introduced into the market which was originally specifically designed for cleaning a person's fingers. That product was sold under the trademark SCRUB DADDY, and is shown in U.S. Design Patent No. D571,515, the subject matter of which is incorporated herein by reference.

When it became apparent that the original SCRUB DADDY product could be used for purposes other than cleaning a person's hands, it was modified to include a slot which resembled a person's mouth. This made the device useful for cleaning forks and spoons and other similar eating utensils. That revised design is the subject of U.S. Design Patent No. D690,892. Again, the subject matter of that design patent is also incorporated herein by reference.

A further modification was also made to the SCRUB DADDY product which made it even more useful. The product has been made from a foam material that changes firmness or rigidity based on the temperature thereof. That is, when the SCRUB DADDY is used in hot water to wash dishes or the like, it is relatively soft. However, in cold water, the sponge becomes relatively rigid and is useful to scrub debris from dishes or countertops or from a person's hands.

It is also well known in the art of scrubbing sponges to cover or enclose the sponge in a netting or mesh-like material having holes therein. The covering adds some scouring ability to the sponge. See, for example, U.S. Pat. Nos. 2,958,885; 4,287,633; 5,671,498 and 7,225,496. The present invention is designed to take advantage of the benefits of all of the foregoing described prior art.

### SUMMARY OF THE INVENTION

The present invention provides an improvement on the prior art. It is an object of the present invention to provide an artificial sponge that changes in firmness or rigidity based on the temperature thereof and which is covered by a plastic mesh to improve the scouring ability of the sponge.

It is a further object of the present invention to provide an artificial sponge that changes in firmness or rigidity based on the temperature thereof, which is covered by a plastic mesh to improve the scouring ability of the sponge and which changes if color to indicate the temperature of the sponge.

In accordance with the illustrative embodiments demonstrating features and advantages of the present invention, there is provided an artificial cleaning sponge made from a foam material that changes firmness or rigidity based on the temperature thereof. The foam sponge is covered or surrounded by a plastic mesh. The sponge may also include thermochromic additives that change the color of the foam based on the temperature. This provides a visual indication of the temperature of the foam.

Other objects, features, and advantages of the invention will be readily apparent from the following detailed description of a preferred embodiment thereof taken in conjunction with the drawings.

### BRIEF DESCRIPTION OF THE DRAWINGS

For the purpose of illustrating the invention, there is shown in the accompanying drawings one form which is presently preferred; it being understood that the invention is not intended to be limited to the precise arrangements and instrumentalities shown.

FIG. 1 is a front perspective view of the scrubbing or scouring pad of the present invention, and

FIG. 2 is a cross-sectional view thereof.

### DETAILED DESCRIPTION OF THE PREFERRED EMBODIMENT

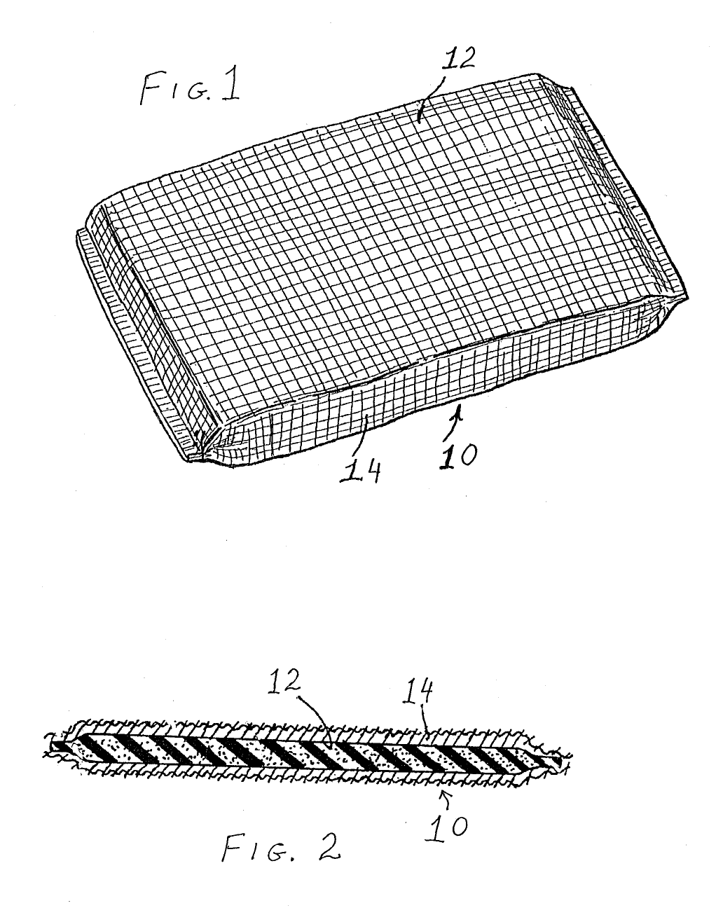

Referring now to the several drawings in detail wherein like reference numerals have been used throughout the various figures to designate like elements, there is shown in FIGS. 1 and 2 a scrubbing or scouring pad constructed in accordance with the principles of the present invention and designated generally as 10. In the preferred embodiment, the pad 10 is generally rectangular in shape. It should be understood, however, that this is by way of example only and that other shapes and appearances could obviously be made.

The pad 10 is made up of essentially two parts: the foam sponge 12 and the mesh cover 14. As explained in Applicant's prior application Ser. No. 13/617,762, the sponge 12 has the characteristics of being relatively rigid at cold temperatures, such as 50-60° F., for example, but becomes softened at elevated temperatures above 100° F., for example. As is known in the art, this is accomplished by utilizing base thermoplastic materials such as polyurethanes, polyesters and related compositions and mixing them with thermoplastic materials that may have soft or putty-like characteristics at different temperatures. Examples are capero-lactones and related thermoplastics such as sold under the names Protoplast or Draco. As is also well known in the art, polymer compositions can be further cross-linked for increased temperature settings, durability, structural strength and the like. In addition, various additives can be employed depending on the use to which the sponge pad is to be used.

A foamed sponge 12 made from the materials described above will have the characteristics of being relatively firm or rigid at cold temperatures but relatively soft at elevated temperatures. The firmness of the foam sponge does, of course, change gradually as the temperature changes, but as is well known in the art, the degree of change and the degree of firmness or hardness of the sponge can be determined by the various ingredients.

In addition to changing firmness, the sponge pad 12 of the present invention also changes color as the temperature changes. This is accomplished by incorporating into the foam thermochromic materials which are, per se, known in the art. These are generally described in U.S. Pat. No. 6,585,555 to Wong et al. and specific examples can be found in Published Application No. US 2006/0287215 to McDonald et al. The entire disclosures of both of these documents are hereby incorporated herein by reference.

It is known to coat the outer surface of a foam product with thermochromic materials so that the outside surface can change color. This can be accomplished by printing the same thereon as described, for example, in the Wong et al. patent. The present invention, on the other hand, includes the thermochromic additives throughout the foam product. This reduces production time and costs and provides for a more uniform product.

To accomplish the foregoing, the foam for preparing a sponge pad is prepared in the normal manner. That is, the polymers and other additives, including foaming agents and the like, are prepared in the conventional manner. Before the material is allowed to foam, however, thermochromic additives are mixed in and dispersed throughout the polymer mixture. The combination is then allowed to foam and is molded or extruded utilizing any well known manufacturing technique.

Numerous and various different thermochromic additives can be utilized. The color of the sponge can change several times as the temperature changes or only a single change or other visual appearance can be selected. The choice of colors may also depend on the specific use to which the sponge is intended. All of these selections are within the scope of the invention and would be recognized by those skilled in the art.

Whether made with or without the thermochromic additives, the sponge 12 of the present invention is covered or surrounded by the mesh covering 14. The mesh could cover only a portion of the sponge 12. Preferably, however, it encapsulates all of the sponge as shown in the figures.

The mesh 14 may be made from a variety of materials, preferably resin material including polyolefins, polyamides, polyesters, and other appropriate materials which produce a durable and functional mesh. Low density polyethylene (LDPE, a polyolefin), poly vinyl ethyl acetate, high density polyethylene, or mixtures thereof are preferred. These are described in U.S. Pat. No. 6,146,745 and the mesh 14 can have the appearance and be produced in the manner describe in this patent. The mesh 14 could also be made and have the appearance as shown in U.S. Pat. Nos. 2,958,885; 4,287,633; 5,671,498 and 7,225,496 referred to above.

While it is known that plastic mesh material improves the scouring ability of a standard sponge, it was unexpectedly found that the use of such mesh 14 is even more beneficial when used with the foam of the present invention. When the sponge 12 is warm and relatively soft, the same works essentially like any of the mesh covered sponges disclosed in the above patents. That is, the combination has some scouring ability. However, when combined with the foam of the present invention and when the foam sponge 12 is cold and more rigid, the scouring ability of the combination is greatly increased. The combination functions much like steel wool but without scratching the surface being scoured.

The present invention may be embodied in other specific forms without departing from the spirit or essential attributes thereof and accordingly, reference should be made to the appended claims rather than to the foregoing specification as indicating the scope of the invention.

We claim:

1. A scouring pad comprising:
a polymer sponge;
said sponge being more rigid at low temperatures and less rigid at higher temperatures, and
a plastic mesh covering said sponge.

2. The scouring pad as claimed in claim 1 wherein said sponge changes its visual appearance when the temperature of the sponge changes.

3. The scouring pad as claimed in claim 2 wherein the change in said visual appearance is a change in color.

4. The scouring pad as claimed in claim 2 including thermochromic particles dispersed throughout said sponge.

5. The scouring pad as claimed in claim 1 wherein said pad is rectangular in shape.

6. A method of producing a thermochromic scouring pad comprising:
mixing foamable polymers with a foaming agent;
mixing compositions with said foamable polymers that have the ability to change the rigidity of said pad with changes in temperature;
mixing thermochromic compositions with said foamable polymers;
allowing said mixture to foam and forming said foamed mixture into a predetermined shaped sponge, and
covering said sponge with a plastic mesh.
